(19) United States
(12) Patent Application Publication
(10) Pub. No.: US 2007/0060286 A1
(43) Pub. Date: Mar. 15, 2007

(54) System and method for progressive drawing-based promotions

(76) Inventor: Mark Sacks, Coronado, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/498,922

(22) Filed: Aug. 3, 2006

Related U.S. Application Data
(60) Provisional application No. 60/709,072, filed on Aug. 16, 2005.

(51) Int. Cl. G06F 19/00

(52) U.S. Cl. 463/18

(57) ABSTRACT

A method and system is provided for conducting progressive, drawing-based promotions. An exemplary method according to the present invention is a method whereby a plurality of participants are entered in a promotion. A personal prize value is established for each participant. Drawing times for selection of one or more winners are established and participants are informed of their personal prize value. One or more drawings is conducted, and qualifying winners of each drawing are awarded their personal prize value at the time of the drawing.

### CROSS-REFERENCE TO RELATED APPLICATION

Priority is claimed under 35 U.S.C. § 119(e) to the U.S. Provisional Patent Application No. 60/709,072, filed on Aug. 16, 2005, entitled “System and Method for Casino Gaming, Bingo, Racetrack, Lottery & Other Gaming Related Marketing & Promotions,” by Mark Sacks, which application is incorporated by reference herein.

### FIELD OF THE INVENTION

The present invention relates to the field of collect-to-win and drawing-based promotions.

### BACKGROUND OF INVENTION

As the number of casinos has grown both in gaming centers such as Las Vegas, Nev., or Atlantic City, N.J., and with the expansion of tribal, riverboat and race track casinos, in order to compete casinos have increasingly turned to promotions to attract players, promote loyalty, and increase revenue. One common prior art promotion based bonus system used by casinos is a progressive gaming system. In a typical progressive gaming system, a plurality of individual gaming units are linked together and collectively generate a large jackpot that builds progressively based on the volume of play on the relevant gaming units. This progressive jackpot may be won by any of the participants using the individual gaming units in the progressive system. The potential for a large payout from the progressive jackpot draws participants to the individual gaming units in the progressive system, and promotes longer play times. Such progressive based systems may drive participants to particular gaming units or increase play at times when the progressive jackpot is large, but they cannot be controlled temporally to drive traffic at particular times and they effectively lose their promotional value upon payout.

Drawing-based promotions are another type of prior art promotion commonly used by casinos and a wide variety of other establishments. Many prior art drawing-based promotions rely on the use of entry tickets or other devices wherein non-winning entries have no value after a particular drawing. In many well known prior art drawing-based promotions, every person who participates in the promotion has a one-time opportunity to win a given prize. Other prior art drawing-based promotions allow participants to accumulate entry tickets over the promotion period in order to increase their chances of winning a prize, which is the same for all participants.

Another popular drawing-based promotion used by casinos is commonly referred to as a “Hot Seat” promotion. In a typical Hot Seat promotion, random or scheduled drawings are conducted in which players who have their member card inserted in a gaming device, or have checked in or been recognized by other means at the time of the drawing, are eligible to win a pre-determined amount or range of amounts which is the same for all participants.

While such drawing-based promotions are effective for inducing participants to frequent a venue such as a casino for a particular drawing, they generally do not provide an adequate incentive to induce repeat visits or extend the duration of a given visit, while concomitantly providing a tangible means to remind the participant that they are participating in a promotion. Another shortcoming of the prior art drawing systems is that all drawing winners, regardless of their level of participation, have an equal chance at the allocated prize(s).

The present invention overcomes the limitations of prior art promotions by awarding personal prize value to each participant. As each participant engages in the activity desired by the organizer they accumulate personal cash or prize value, hereafter referred to as PPV. An individual's accumulated PPV can be displayed on a game board with associated game pieces, a display screen, a promotional ticket, or any other display medium. The PPV game board, promotional ticket or other display medium may also display other pertinent promotion information, such as drawing times and activity needed to build the participant's PPV. Multiple drawings are held within the promotion period, and the winners of each drawing receive their accumulated PPV.

Unlike prior art promotions in which the non-winners have no continued value, in the present invention a participant's PPV increases as the promotion progresses. Participants with non-winning tickets in one drawing will not simply discard their game board or promotional ticket. Instead, participants will save their game boards or tickets for the next drawing, or the next time they visit the venue during the promotion. The organizer can establish the promotion such that participants maintain their PPV for the duration of the promotion, across multiple promotions, or until won (at which point they may start over at any point in the promotion period).

Thus, the present invention provides a flexible promotion that can be used to drive particular behavior at particular times, promoting loyalty as participants return repeatedly for drawings during the promotion period.

### SUMMARY OF INVENTION

A method and system is provided for conducting progressive, drawing-based promotions. An exemplary method according to the present invention is a method whereby a plurality of participants are entered in a promotion. A personal prize value is established for each participant. Drawing times for selection of one or more winners are established and participants are informed of their personal prize value. One or more drawings is conducted, and qualifying winners of each drawing are awarded their personal prize value at the time of the drawing.

### BRIEF DESCRIPTION OF THE DRAWINGS

FIG. 1 is an illustration of a sample PPV ticket.

FIG. 2 is an illustration of the front side of a sample PPV game board.

FIG. 3 is an illustration of a back side of a sample PPV game board.

FIG. 4 is an illustration of a game board-based embodiment of the present invention.

FIG. 5 is an illustration of a ticket-based embodiment of the present invention.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the preferred embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

The present invention incorporates two fundamental features that can be implemented in a wide variety of different ways depending on the venue and the desired participant conduct. The first fundamental feature is a personal accumulation of value referred to herein as “personal prize value” or “PPV”. Each participant in a given promotion accumulates PPV, which grows progressively more valuable each time that participant engages in the activity that is the subject of the promotion during the designated time period. This method of accumulation provides a strong incentive for participants to take advantage of every available opportunity to build their PPV.

PPV awards may be fixed, or may have tiered values based on fixed percentages within pre-determined prize tables. Prize tables allow organizers to assign a range of prize values and to establish a hierarchy of tiers upon which prize values are based. The organizer of the promotion may use prize tables to estimate the average liability at each drawing, and to budget the maximum liability for the promotion (based on 100% participation).

Unlike prior art casino progressive jackpot promotions and bonus systems in which even the weakest participant has an opportunity to win the largest prize, by utilizing the PPV prize table method, the organizer's liability is commensurate to the participant's activity.

It will be apparent that the organizer can set up promotions using the present invention such that participants build their PPV based on any behavior or activity that the organizer would like to promote. For example, if a casino wants to promote its video poker or slot machines, participants may accumulate PPV by playing video poker or slot machines. If a casino wants to induce participants into its table gaming area at particular times of day, it may award PPV to participants that enter the casino at those times. Casinos may also award PPV based on Players' Club reward points earned, coin-in, time at device, visit frequency, or any other measurable method.

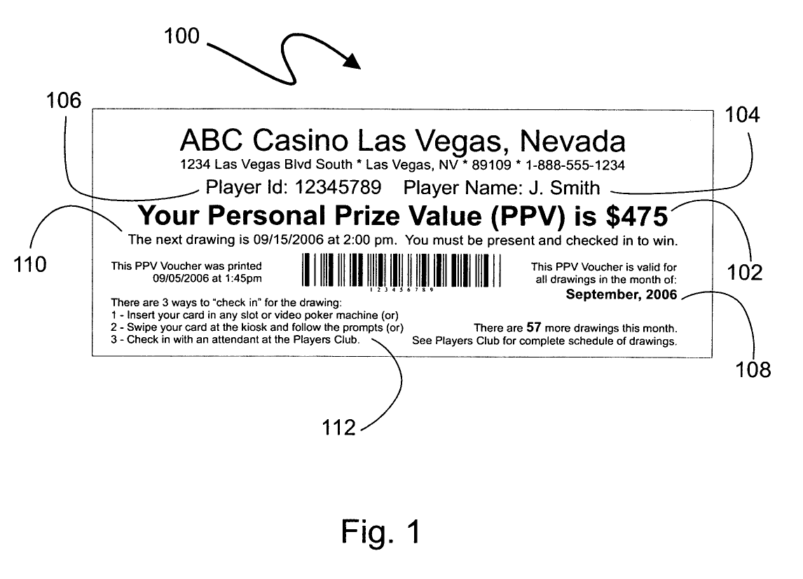

The second fundamental feature is delivery of a physical representation of the participant's PPV. This physical representation may take almost any form. Without limitation, some common examples would include a game board, a ticket, a card, or an electronic message such as an e-mail, text or other wireless message, or even a display on a screen. Referring to FIG. 1, in one embodiment the physical representation of a participant's PPV is a ticket 100. Such a ticket indicates the participant's current PPV 102, and may also include a variety of other information such as participant name 104, participant identification number 106, promotion period 108, drawing times or windows 110, promotion rules 112, etc.

The physical representation of the participant's PPV provides tangible value to the participant even after they leave the venue or have a non-winning session. It also serves as a reminder that the participant is involved in an ongoing promotion, providing an incentive to return at a specific day or time. The physical representation may also provide the participant with a variety of relevant information such as a schedule of the next drawing time, number of drawings that remain, instructions on how to check in for drawings, or any other promotion information the organizer wishes to convey.

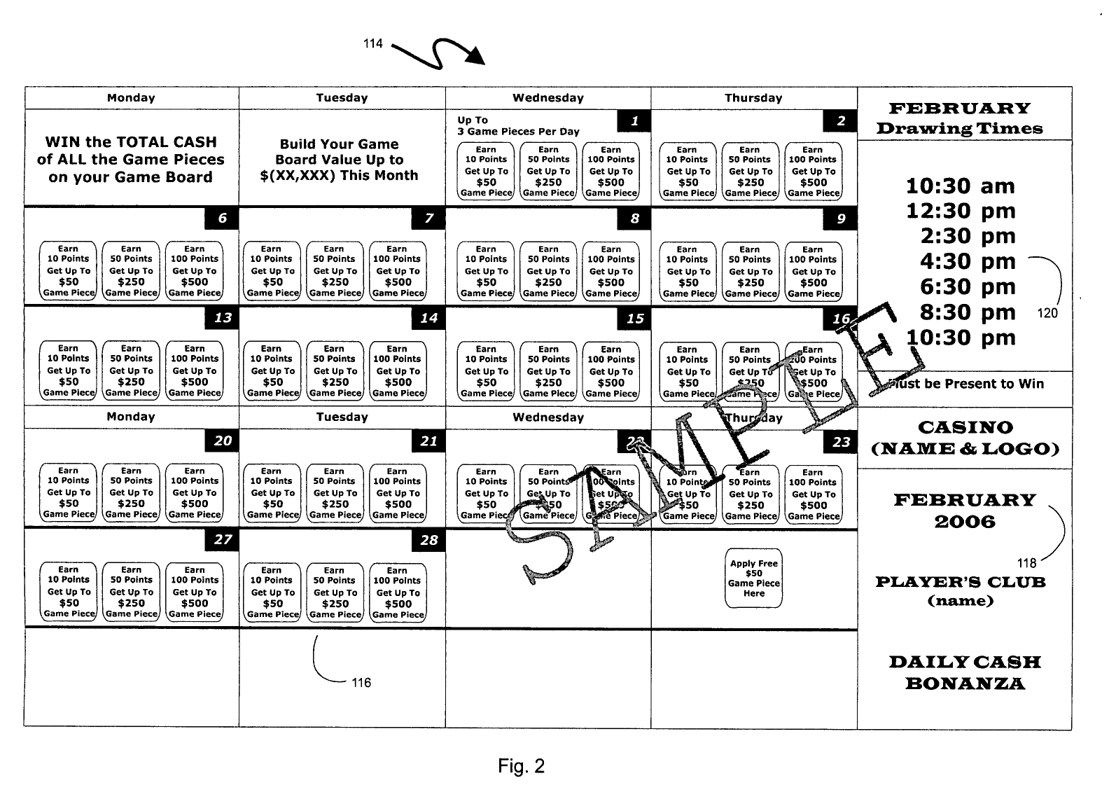

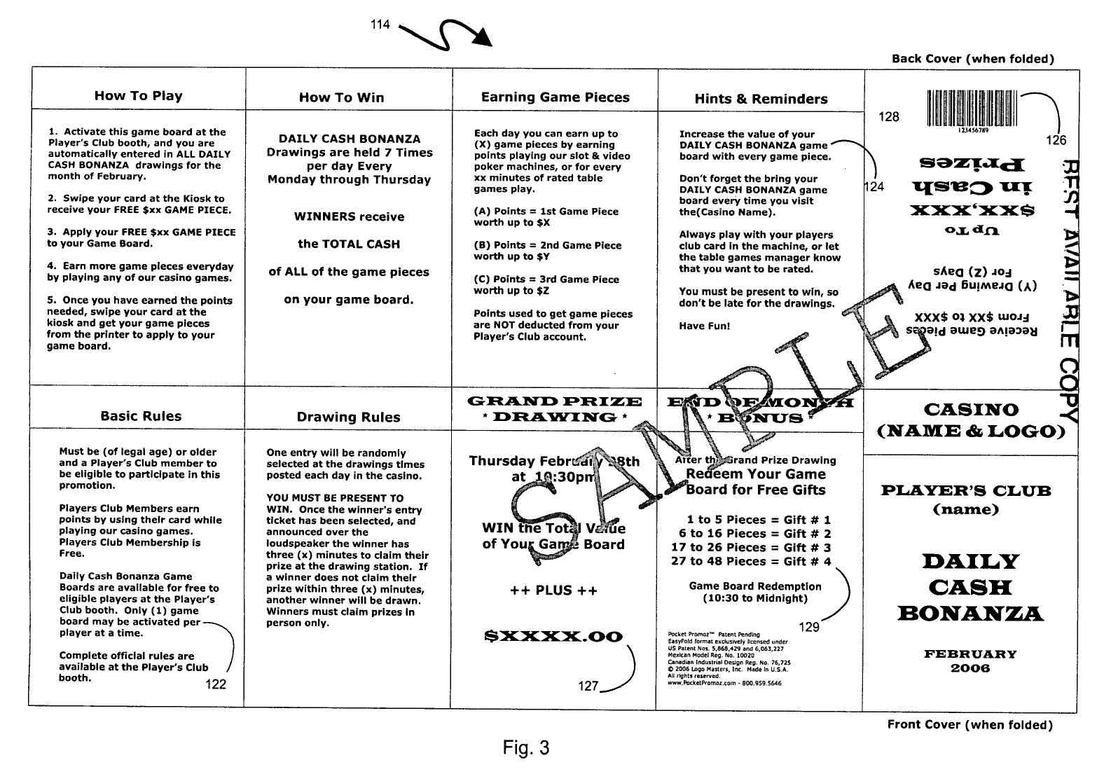

Using these two fundamental features, the organizer can configure a promotion using the present invention in a variety of ways. Referring to FIGS. 2 and 3, in one embodiment, the drawing-based promotion of the present invention uses a game board 114 for the physical representation of the participant's PPV. Game boards may include game piece spaces 116, a promotion time period 118 and drawing schedule 120, game rules and procedures 122, as well as other reminders, promotions and events 124 scheduled at the casino or other venue. In one embodiment, game boards may be uniquely identified and security enabled such as through the use of bar coding 126, sequential numbering 128, etc.

In one game board embodiment, participants earn and accumulate game pieces during the period of the promotion whereby the participant's PPV is the cumulative value of all of the game pieces that have been affixed to their game board. Game pieces may be computer generated, uniquely bar-coded, self adhesive labels whereby the PPV is revealed upon computerized printing, and the cumulative value is determined by scanning each uniquely bar-coded computer generated game piece. In one embodiment game pieces may be manually distributed self-adhesive scratch-off stickers or bi-level die cut piggyback labels, whereby the PPV is hidden from view until scratched or peeled to reveal the hidden value and the cumulative value is determined by manually totaling the revealed value of each game piece.

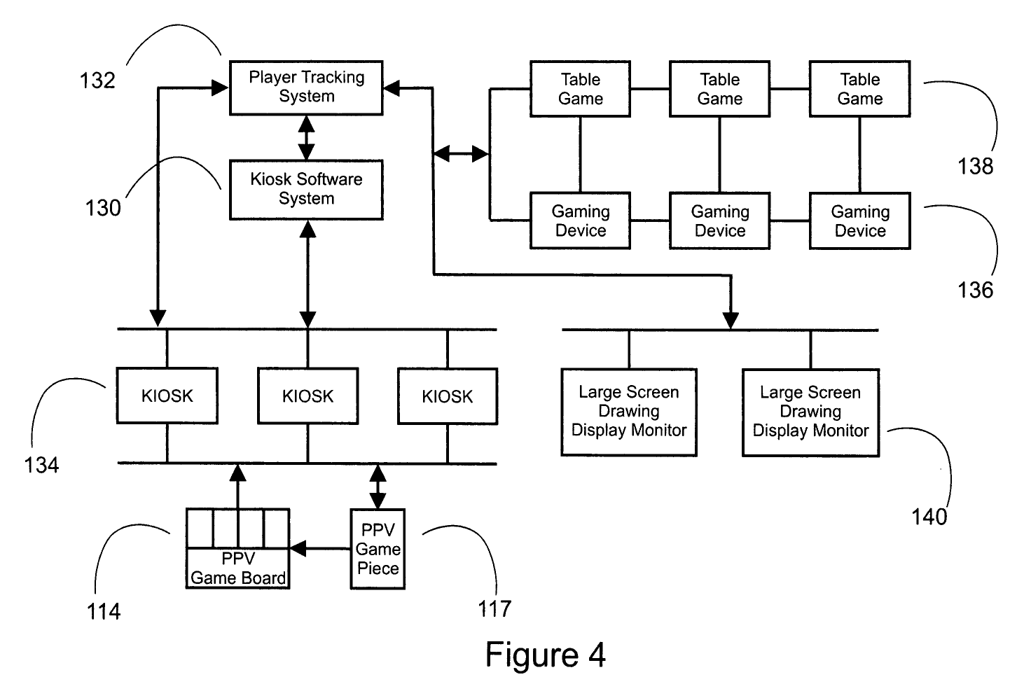

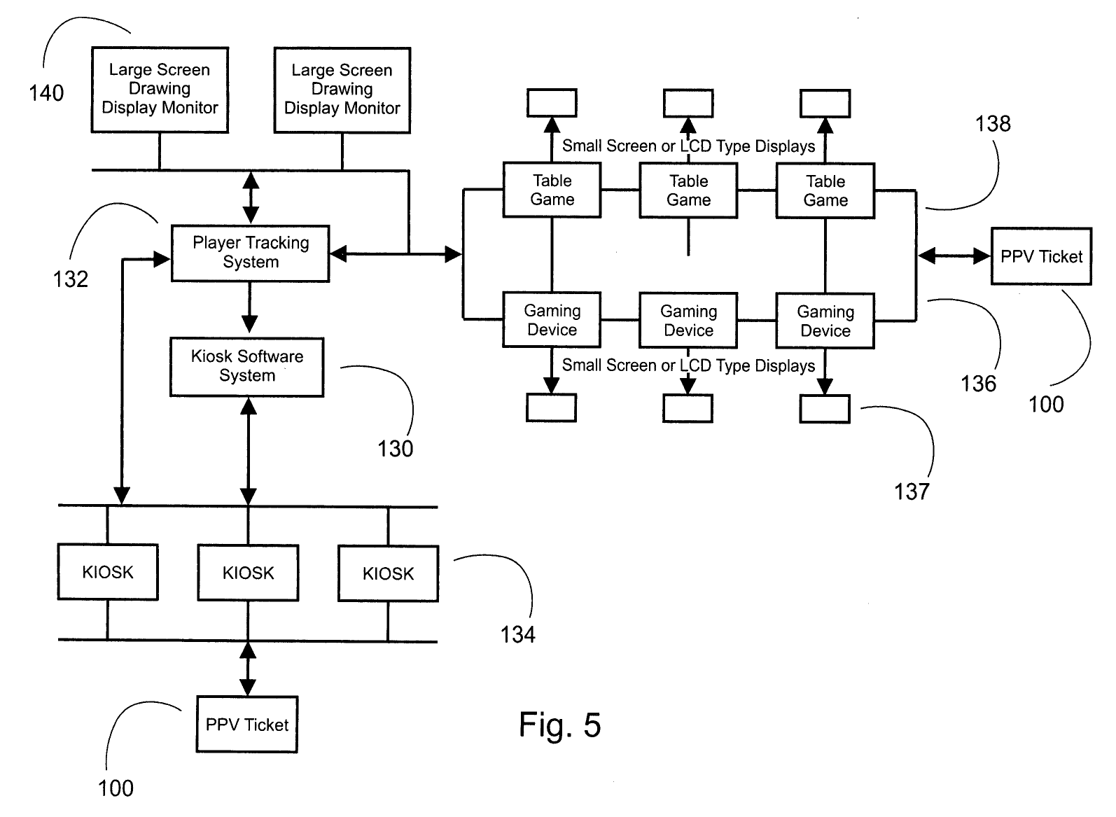

Referring to FIGS. 4 and 5, in one embodiment, the physical representation of the participant's PPV is delivered to the participant via a kiosk-based system 130 which is integrated with the casino's player tracking system 132. In this embodiment, participants may utilize a kiosk 134 to initiate participation in the promotion, check their PPV, check in for drawings, print earned and bonus PPV game tickets 100, print drawing schedules, review promotion rules, or obtain any other available information the casino desires to make available. The physical representation of the participant's PPV may be delivered to the participant via a kiosk 134, directly at a gaming device 136 such as a slot machine, video poker machine or table game 138 such as blackjack, craps or roulette, or via a display monitor 140. In one embodiment, participants may initiate participation in the promotion, check their PPV, check in for drawings, print PPV tickets, or any other available information the casino desires to make available at one or all of these devices. In one embodiment, the gaming devices and table games may also include individual display screens 137 for delivery of information, including PPV.

Many casinos and other venues offer loyalty clubs which require participants to create a member profile. In one embodiment, each participant is assigned a unique identifier associated to their member profiles.

In one embodiment, each promotion participant receives one entry into all drawings established for the promotion period. In another preferred embodiment, participants may be awarded additional entries by engaging in certain activity desired by the casino, or by reaching certain tiers within the promotion prize table.

In one embodiment, during the period of the promotion, the organizer of the promotion conducts a number of drawings. At each drawing one or more promotion participants will be randomly selected to win their PPV. The promotion period can be of any duration and may include any number of drawings. Drawings may occur at scheduled times, fixed intervals, within specified time periods, or in any other way the organizer chooses. In one embodiment, the promotion participants are electronically entered into drawings, and drawing winners are Selected randomly utilizing computer software, and displayed directly on the gaming device 136 or on large screen monitors 140 within the casino. In another embodiment, promotion participants are manually entered and entry tickets are randomly selected from a drawing drum.

In one embodiment, the rules require that the winner be physically present in the casino at the time of the drawing or to have “checked in” subsequent to the previous drawing, but prior to the next scheduled drawing. In another embodiment, the winner is not required to be present at the time of the drawing, and if selected may be notified by any means, including electronic means such as electronic mail, text message, RFID signal or other wireless messaging services.

In one embodiment, drawing winners will receive the full value of the PPV in cash. In another embodiment, the promotion rules may state that drawing winners will have the option of receiving the full value of their PPV in credits, including restricted credits that can be used only for particular purposes or that they may receive a predetermined percentage of their PPV in cash.

In one embodiment, the organizer may culminate each promotion period with a grand prize bonus drawing and may also provide a consolation prize for participants who collect a threshold PPV, but do not win any of the drawings.

The present invention is broadly applicable to almost any loyalty-based program across a wide variety of industries. Gaming venues have previously been discussed in connection with several embodiments, but the invention is broadly applicable in the context of promotions generally. By way of example and without limitation, the airline industry may use PPV as a secondary bonus award to existing miles reward programs. If a grocery store wants to increase its sales on certain days each month, it may award PPV to participants who shop on those days. Financial institutions, credit card companies, and retail operators of all types could also use the PPV system to enhance their loyalty and continuality programs. As discussed with regard to casino venues, members of any such loyalty program could be awarded PPV based on any activity desired by the organizer in order to motivate the desired activity. The organizer of the promotion could then conduct multiple drawing times at which point individual participants would be eligible to win their accumulated PPV.

By utilizing the present invention, casinos and other organizers of loyalty based programs will be able to drive specific activity within a defined promotion period that increases as the promotion period progresses, and have a tangible method to induce extended patronage and repeat visitation to the organizer's establishment.

It will be understood by those of ordinary skill in the art that although the present invention has generally been described in relation to a single venue or organization, the present invention can be broadly applied across multiple venues or organizations without limitation.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims:

What is claimed is:

1. A method for conducting a promotion, the method comprising:
a. entering a plurality of participants in a promotion;
b. establishing a personal prize value for each participant;
c. establishing drawing times for selection of one or more winners;
d. informing said participants of their personal prize value;
e. conducting one or more drawings;
f. awarding the qualifying winner of the drawing their personal prize value at the time of the drawing.

2. The method of claim 1, wherein the personal prize value assigned to said participant increases as the promotion progresses.

3. The method of claim 1, wherein the personal prize value assigned to said participant increases based on participant's engagement in one or more specified activity.

4. The method of claim 1, wherein the personal prize value assigned to said participant increases based on the amount of money spent by said participant.

5. The method of claim 1, wherein the personal prize value assigned to said participant increases based on the amount of money wagered by said participant.

6. The method of claim 1, wherein the personal prize value assigned to said participant increases based on a value in a prize table.

7. The method of claim 1, wherein the personal prize value assigned to said participant increases based on said participant's presence at the venue within a specified period of time.

8. The method of claim 1, wherein said participants are informed of their personal prize value on a ticket.

9. The method of claim 1, wherein said participants are informed of their personal prize value by an electronic message.

10. The method of claim 1, wherein said participants are informed of their personal prize value by a game board.

11. The method of claim 1, wherein said participants are informed of their personal prize value by a radio frequency signal.

12. The method of claim 1, wherein said drawing times are set at a specific time of day.

13. The method of claim 1, wherein said drawing times are set to occur within a specific period of time.

14. The method of claim 1, wherein said participants must check-in to qualify for a drawing.

15. An apparatus for conducting a progressive, drawing-based promotion comprising:
a. a game board displaying spaces for game pieces;
b. game pieces displaying a participant's personal prize value earned by participation in a promotion.

16. An apparatus for conducting a progressive, drawing-based promotion comprising a ticket displaying personal prize value earned by participation in a promotion and additional information regarding the promotion.
